(19) United States
(12) Patent Application Publication
(10) Pub. No.: US 2016/0349105 A1
(43) Pub. Date: Dec. 1, 2016

(54) Portable Weight Scale

(71) Applicant: Nami Oneda, Honolulu, HI (US)

(72) Inventor: Nami Oneda, Honolulu, HI (US)

(21) Appl. No.: 15/167,333

(22) Filed: May 27, 2016

Related U.S. Application Data
(60) Provisional application No. 62/166,847, filed on May 27, 2015.

(51) Int. Cl. G01G 21/28; G01G 23/18; G01G 19/44

(52) U.S. Cl. CPC G01G 21/28; G01G 19/44; G01G 23/18

(57) ABSTRACT

A portable weight scale for allowing a user to weigh himself or other objects while travelling. The portable weight scale includes a scale pad having one or more pivotally adjoined sections so as to allow the scale pad to be folded into a folded configuration for storage. The scale pad further includes a weighing mechanism therein, wherein the weighing mechanism is adapted to determine the weight of an object placed on the scale pad. A control circuit operably connects the weighing mechanism to a microprocessor, and a wireless transmitter for communicating weight information to a mobile electronic device.

### CROSS REFERENCE TO RELATED APPLICATION

This application claims the benefit of U.S. Provisional Application No. 62/166,847 filed on May 27, 2015. The above identified patent application is herein incorporated by reference in its entirety to provide continuity of disclosure.

### BACKGROUND OF THE INVENTION

### Field of the Invention

The present invention relates to weight scales. More specifically, the present invention provides a portable weight scale that is adapted to wirelessly communicate with a mobile electronic device, such as a smartphone or tablet, among others.

While away from home or traveling, it can be difficult for a person to monitor his or her weight. This is particularly true for people who are away from home for an extended period of time. However, people with weight issues or who are on restricted diets may need to frequently monitor their weight in order to keep track of their eating habits and general health. Without having a scale provided by a hotel or other facility, the user has no way to determine his or her weight.

Some people travel with conventional bathroom scales, and store the scale in a suitcase or briefcase. However, conventional bathroom scales are large and bulky, and cannot be easily stored within a suitcase. Further, the scale can consume considerable space within the suitcase, which can be undesirable when the person must also pack various clothes, shoes, and other items therein. Thus, a portable scale that can be easily transported while traveling is desired.

Devices have been disclosed in the prior art that relate to weight scales. These include devices that have been patented and published in patent application publications. These devices generally relate to weight scales for use with computers, cell phones, and other devices, such as U.S. Published Patent Application Number 2014/0224551, U.S. Published Patent Application Number 2014/0089231, U.S. Pat. No. 8,921,716, U.S. Published Patent Application Number 2014/0262549, and U.S. Pat. No. 8,901,442.

These prior art devices have several known drawbacks. While the devices in the prior art disclose various weight scale devices, such devices are not easily transported by the user. Further, the devices in the prior art fail to provide a portable weight scale comprising a scale pad that can be folded for storage and that includes a wireless transmitter for communicating with a mobile electronic device.

In light of the devices disclosed in the prior art, it is submitted that the present invention substantially diverges in design elements from the prior art and consequently it is clear that there is a need in the art for an improvement to existing portable weight scale devices. In this regard the instant invention substantially fulfills these needs.

### SUMMARY OF THE INVENTION

In view of the foregoing disadvantages inherent in the known types of weight scales now present in the prior art, the present invention provides a new weight scale wherein the same can be utilized for providing convenience for the user when weighing himself or other objects while traveling.

The portable weight scale comprises a scale pad having a weighing mechanism therein for determining the weight of an item placed on the scale pad. The scale pad is preferably foldable about a fold-line so that the scale pad can be folded into a folded configuration for storage. The scale pad may have a display for displaying the item's weight or may comprise a control circuit having a wireless transmitter for transmitting the weight information to a mobile electronic device.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the portable weight scale in an unfolded configuration.

FIG. 1B shows a perspective view of the portable weight scale in a partially folded configuration.

FIG. 2 shows a schematic diagram of the components of the portable weight scale.

### DETAILED DESCRIPTION OF THE INVENTION

Reference is made herein to the attached drawings. Like reference numerals are used throughout the drawings to depict like or similar elements of the portable weight scale. For the purposes of presenting a brief and clear description of the present invention, the preferred embodiment will be discussed as used for providing a user with a means for weighing himself or herself while traveling. The figures are intended for representative purposes only and should not be considered to be limiting in any respect.

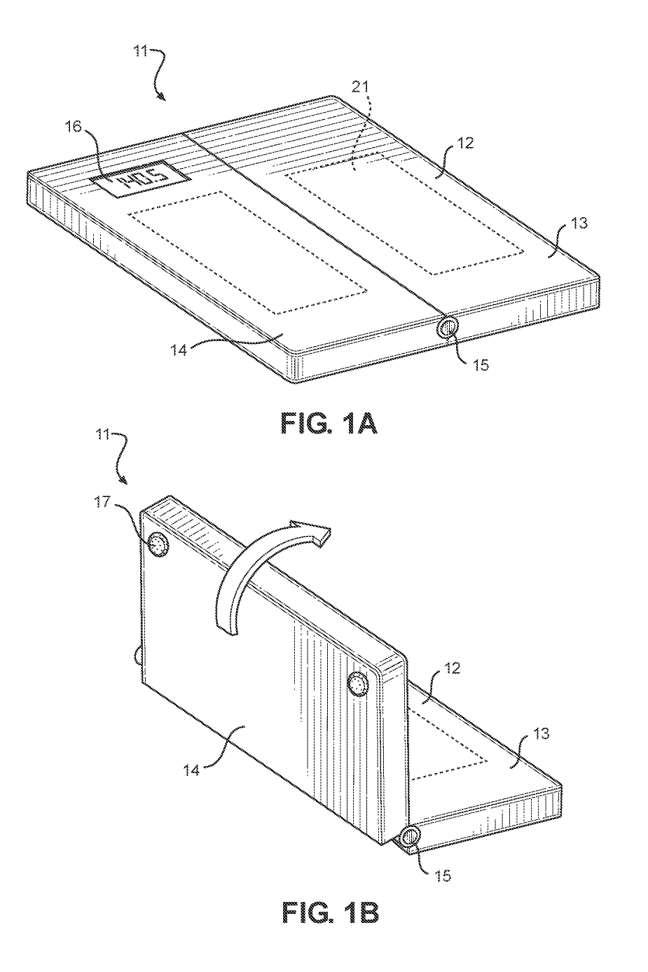

Referring now to FIGS. 1A and 1B, there are shown perspective views of the portable weight scale in an unfolded and partially folded configuration, respectively. The portable weight scale 11 comprises a scale pad 12 on which a user can place an object in order to determine the weight thereof. The scale pad 12 is preferably rectangular in configuration, however, other configurations are suitable in alternative embodiments. The scale pad 12 is preferably divided into a plurality of sections so that the scale pad 12 can be folded into a folded configuration for storage. In the illustrated embodiment, the scale pad 12 is divided into a first section 13 and a second section 14, wherein the first and second sections 13, 14 are pivotally adjoined via a hinge 15 that allows the first and second sections 13, 14 to be folded into the folded configuration.

In the shown embodiments, the first and second sections 13, 14 are generally sized equally, such that in the folded configuration, the first and second sections 13, 14 substantially overlap. Further, the hinge 15 is configured to provide for a single vertical axis fold-line, however, in alternative embodiments, the hinge 15 may be configured to provide for multiple fold-lines or fold-lines along any axis.

The scale pad 12 is preferably substantially planar in the unfolded configuration so that a user can stand thereon, or place an object thereon in order to determine the weight thereof. A weighing mechanism 21 is embedded in the scale pad 12 for determining the weight of objects placed thereon. The weighing mechanism 21 may be mechanical or electrical, depending upon the embodiment. In some embodiments, the weighing mechanism 21 comprises a piezoelectric element. In other embodiments, the weighing mechanism 21 comprises a pressure sensor. Various weighing mechanisms 21 for determining the weight of an object can be used, such as one or more weight sensors positioned within the scale pad 12.

The underside of the scale pad 12 preferably comprises a slip resisting element. In the illustrated embodiment, the underside of the scale pad 12 comprises a plurality of feet 17 for engaging the floor. The feet 17 are preferably composed of rubber or another non-slip material to help prevent the scale pad 12 from moving when placed on a floor or other surface. In alternative embodiments, the entire underside of the scale pad 12 may have a non-slip coating or layer to prevent the scale pad 12 from moving.

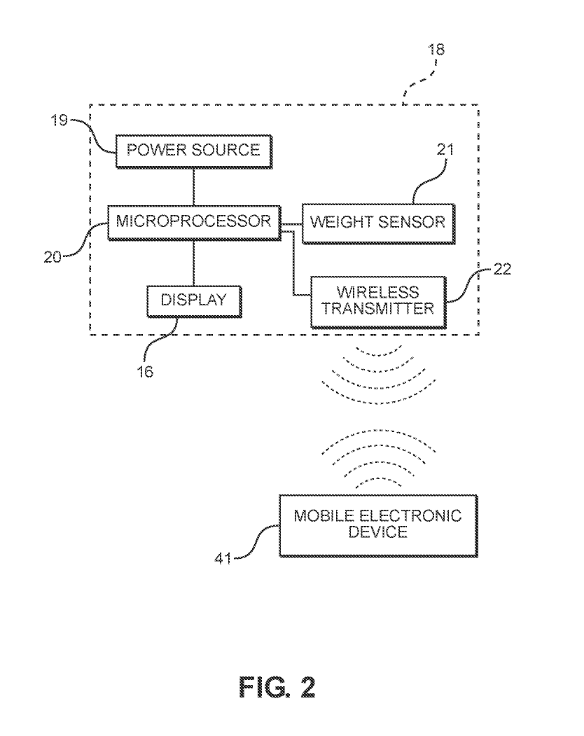

Referring now to FIG. 2, there is shown a schematic diagram of the components of the portable weight scale. The portable weight scale 11 further comprises a control circuit 18. The control circuit 18 comprises a weighing mechanism 21 (such as a weight sensor), a power source 19, and a microprocessor 20. The weight mechanism 21 determines the weight of an object placed on the scale pad. In some embodiments, the control circuit includes a display 16 that is positioned on the scale pad so as to display the weight of the object for the user to see. In alternative embodiments, the control circuit 18 additionally or alternatively includes a wireless transmitter 22. The wireless transmitter 22 is adapted to communicate with a mobile electronic device 41 such as a smartphone, tablet, laptop, among other similar devices. In this way, the weight of the object can be shown on the user's mobile device to allow the user to easily view and save the weight information or use the information in conjunction with a software application.

Thus, the portable weight scale provides the user with a scale pad that can be folded into a folded configuration for storage. The scale pad can be unfolded for use and placed on a horizontal support surface. The weighing mechanism within the scale pad allows the user to determine the weight of an object placed on the scale pad. The weight can be displayed on a display incorporated into the scale pad, or the weight can be wirelessly transmitted to a mobile electronic device via a wireless transmitter of the control circuit of the scale pad.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A portable weight scale, comprising:
a scale pad having one or more pivotally connected sections, wherein the scale pad can be folded into a folded configuration for storage;
a weighing mechanism embedded within the scale pad adapted to determine the weight of an object placed thereon;
a control circuit comprising the weighing mechanism and a wireless transmitter, wherein the wireless transmitter is in electronic communication with the weighing mechanism and adapted to wirelessly transmit weight information determined by the weighing mechanism to a mobile electronic device.

2) The portable weight scale of claim 1, wherein the one or more pivotally connected sections comprises a first section pivotally affixed to a second section via a hinge.

3) The portable weight scale of claim 1, wherein the weighing mechanism comprises one or more weight sensors.

4) The portable weight scale of claim 1, wherein the control circuit further comprises a microprocessor.

5) The portable weight scale of claim 1, wherein the control circuit further comprises a power source.

6) The portable weight scale of claim 1, wherein the control circuit further comprises a display, wherein the display is positioned on the scale pad so as to display weight information determined by the weighing mechanism.
